(19) United States
(12) Patent Application Publication
(10) Pub. No.: US 2022/0333309 A1
(43) Pub. Date: Oct. 20, 2022

(54) Coated Film For Laminating Substrates Made From Biodegradable Materials

(71) Applicant: Celanese International Corporation, Irving, TX (US)

(72) Inventors: Ramune Shepherd, Derby (GB); Kevin G. Parker, Derby (GB)

(21) Appl. No.: 17/725,056

(22) Filed: Apr. 20, 2022

Related U.S. Application Data
(60) Provisional application No. 63/177,265, filed on Apr. 20, 2021.

(51) Int. Cl. D21H 19/82; C08J 5/18; C08J 7/04; C08J 7/052; D21H 23/64; D21H 19/20; D21H 19/34; D21H 19/28; B32B 27/30; B32B 23/20; B32B 23/08; B32B 29/00; B32B 27/10; B32B 23/06; B32B 27/22

(52) U.S. Cl. CPC D21H 19/824; C08J 5/18; C08J 7/0427; C08J 7/052; D21H 23/64; D21H 19/20; D21H 19/34; D21H 19/28; B32B 27/306; B32B 23/20; B32B 23/08; B32B 29/00; B32B 27/10; B32B 23/06; B32B 27/22; C08J 2429/04; C08J 2301/12; C08J 2301/02; C08J 2367/04; B32B 2307/412; B32B 2307/414; B32B 2255/12; B32B 2307/7163; B32B 2307/408

(57) ABSTRACT

A coating composition is described that can be completely biodegradable and well suited for use in laminating films to substrates. The coating composition contains a biodegradable polymer, such as a polyvinyl alcohol polymer. The coating composition can be applied to a biodegradable film and then adhered to a substrate, such as a paper substrate.

### RELATED APPLICATIONS

The present application is based upon and claims priority to U.S. Provisional Patent Application Ser. No. 63/177,265, having a filing date of Apr. 20, 2021, and which is incorporated herein by reference.

### BACKGROUND

Thermal laminating materials and methods are known for protecting paper substrates, such as printed substrates, by adhering a protective thermoplastic polymer cover film or sheet to at least one surface of the paper substrate. The thermal laminating film can serve various different purposes. For instance, the thermal laminating film can protect the paper substrate and any print applied to the substrate. In addition, the thermal laminating film can improve the appearance and durability of the substrate. In some applications, the thermal laminating layer can protect the paper layer from ultraviolet light and can make the substrate resistant to scratching, fading and smudging.

In the past, adhesives for thermal lamination films were conventionally made containing ethylene vinyl acetate polymers. These adhesives, however, are not generally biodegradable. Thus, the laminating adhesive had a tendency to prevent the laminated substrate from entering the recycling stream.

In view of the above, a need exists for a thermal laminating adhesive that is biodegradable. A need also exists for a biodegradable coated film suitable for laminating to substrates, such as paper substrates.

### SUMMARY

In general, the present disclosure is directed to a coated film well suited for use in thermal lamination processes. The coated film can be formulated to be transparent or translucent. Consequently, the coated film can be laminated to a substrate with surface print or ornamentation for protecting the substrate while being able to view the printed matter or ornamentation through the film. In one aspect, the film, the coating, or both, can be made from biodegradable materials. For example, in one aspect, when laminated to a paper substrate, the resulting laminate can be approved for use in entering the paper recycle stream.

In one aspect, for instance, the present disclosure is directed to a coated film comprising a film layer. Applied to one surface of the film layer is a coating. In accordance with the present disclosure, the coating comprises a partially hydrolyzed polyvinyl alcohol. The polyvinyl alcohol, for instance, can be contained in the coating in an amount greater than about 15% by weight, such as in an amount greater than about 20% by weight, such as in an amount greater than about 30% by weight, such as in an amount greater than about 40% by weight, such as in an amount greater than about 50% by weight, such as in an amount greater than about 60% by weight, such as in an amount greater than about 70% by weight. The polyvinyl alcohol can be water soluble. In one aspect, the coating is formulated such that the coating has a melting temperature of less than about 180° C. For example, the melting temperature of the coating can be from about 80° C. to about 150° C., such as from about 90° C. to about 120° C.

In one aspect, the coating further optionally contains a coating plasticizer. The coating plasticizer can comprise, for instance, glycerol, ethylene glycol, diethylene glycol, triethylene glycol, polyethylene glycol, trimethylol propane, trimethylene glycol, tetramethylene glycol, butane diol, neopentyl glycol, or a fatty acid monoglyceride. The coating plasticizer can be present in the coating generally in an amount greater than about 3% by weight, such as in an amount greater than about 8% by weight, such as in an amount greater than about 10% by weight, and generally in an amount less than about 30% by weight, such as in an amount less than about 20% by weight.

The coating can be free or substantially free of ethylene vinyl acetate. The coating can be heat activatable for bonding to adjacent surfaces, such as paper layers. In one aspect, the coating can be relatively thin and have a thickness of less than about 20 microns, such as less than about 15 microns, such as less than about 10 microns.

As described above, the polyvinyl alcohol contained in the coating can be partially hydrolyzed. For instance, the polyvinyl alcohol can be from about 74 mol % hydrolyzed to about 98 mol % hydrolyzed, such as from about 80 mol % hydrolyzed to about 96 mol % hydrolyzed. In one aspect, the polyvinyl alcohol is not crosslinked.

The film layer can generally be made from any suitable film. In one aspect, the film layer is biodegradable. For instance, the film layer can be made from cellulose acetate or regenerated cellulose. The film layer can also be made from polylactic acid, a polyhydroxyalkanoate, or mixtures thereof. In addition the polylactic acid and/or the polyhydroxyalkanoate can be combined with a cellulose ester polymer.

Optionally, a primer layer can be positioned between the film surface and the coating. The primer layer can have a thickness of less than about 5 microns, such as less than about 3 microns and generally greater than about 0.3 microns. The primer layer can comprise an acrylic polymer or polyurethane and can improve adhesion between the film surface and the coating.

The present disclosure is also directed to a laminated product. The laminated product includes a first layer or substrate having a first surface. The coated film as described above is laminated to the first surface of the first layer. The coating is positioned in between the first layer and the film layer. The first layer, for instance, may comprise a paper layer. Once laminated to the paper layer, the film layer can be transparent or translucent. For instance, the film layer may be completely transparent or may have a matte finish.

Other features and aspects of the present disclosure are discussed in greater detail below.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a coated film for use in thermal lamination processes. The coated film includes a film layer adhered to a coating. The coating contains one or more thermoplastic polymers and is well suited for bonding to adjacent surfaces. In accordance with the present disclosure, the coating can be biodegradable and/or be made from biodegradable materials. In one embodiment, the film layer can also be made from biodegradable materials. The coated film can be used as a protective or barrier layer for lamination to all different types of substrates, such as paper substrates.

In the past, for instance, many coated films included a coating made from ethylene vinyl acetate. Although ethylene vinyl acetate can provide excellent bond strength, the material is not compostable or biodegradable. In addition, laminates made from an ethylene vinyl acetate coated film are not suitable or permitted to enter the recycle stream, such as the paper waste stream. In accordance with the present disclosure, the extrusion coated film of the present disclosure includes a coating made from polyvinyl alcohol. In one aspect, the polyvinyl alcohol coating can be used in combination with a biodegradable film, such as a film made from a cellulose acetate polymer. The resulting coated film is fully compostable. In addition, the coated film is recyclable in the paper waste stream. For example, in one embodiment, the polyvinyl alcohol polymer incorporated into the coating can be water soluble and can dissolve in water during a recycling process. For instance, the polyvinyl alcohol can dissolve in water during the repulping process. Although water soluble, the polyvinyl alcohol polymer can also provide significant bond strength between the film and the substrate, especially paper substrates.

Coated films made according to the present disclosure offer various benefits and advantages. For example, the coated film of the present disclosure can be formulated to have excellent transparency and gloss characteristics. Alternatively, the coated film can be formulated to be translucent. The coated film of the present disclosure, when bonded to a substrate, can provide excellent barrier properties to many different substances including mineral oils, hydrocarbons, and organic solvents. The coated film also has excellent barrier properties to gases, such as oxygen, nitrogen, carbon dioxide, and the like. The coated film can also possess excellent mechanical properties, such as elongation, tensile strength, and tear resistance. All of the above benefits can be realized while still producing a product that is biodegradable. When laminated to paper products, for instance, the resulting laminate can fulfill industrial or home compostability credentials, can be repulpable, and can be approved for being recycled in the paper waste stream.

In addition to the above, the coating of the present disclosure containing the polyvinyl alcohol polymer can also be formulated for application to a film layer in very thin layers while still retaining all of the bonding properties necessary for lamination to an adjacent substrate. The coating composition, once applied to a film and dried, for instance, can have a thickness of less than 50 microns, such as less than about 30 microns, such as less than about 20 microns, such as less than about 15 microns, such as less than about 10 microns, such as less than about 7 microns. The thickness of the coating, once dried, is generally greater than about 0.5 microns, such as greater than about 1 micron.

The coating of the present disclosure applied to the film layer, as described above, contains a polyvinyl alcohol polymer. In one aspect, the polyvinyl alcohol polymer is partially hydrolyzed. In this manner, the polyvinyl alcohol polymer contained in the coating can exist as a copolymer. The amount the polyvinyl alcohol polymer is hydrolyzed can depend upon the particular application and the desired result. For instance, the amount the polymer is hydrolyzed can depend upon the desired water solubility of the polymer, the substrate to which the coating is to adhere, the other components contained within the coating, and the suitability of the polymer for use in thermal lamination processes. In general, the polyvinyl alcohol polymer can be hydrolyzed in an amount from about 74 mol % to about 98 mol %, including all increments of 1 mol % therebetween. For example, the polyvinyl alcohol polymer can be at least about 76 mol % hydrolyzed, such as at least about 78 mol % hydrolyzed, such as at least about 80 mol % hydrolyzed, such at least about 82 mol % hydrolyzed, such as at least about 84 mol % hydrolyzed, such as at least about 86 mol % hydrolyzed, such as at least about 88 mol % hydrolyzed, such as at least about 90 mol % hydrolyzed, such as at least about 92 mol % hydrolyzed. The polyvinyl alcohol polymer is typically less than about 96 mol % hydrolyzed, such as less than about 94 mol % hydrolyzed, such as less than about 92 mol % hydrolyzed, such as less than about 90 mol % hydrolyzed, such as less than about 88 mol % hydrolyzed.

The molecular weight of the polyvinyl alcohol polymer can also vary depending upon the particular application. For example, in one embodiment, a polyvinyl alcohol having a relatively high molecular weight may be used. Alternatively, the coating composition can contain a lower molecular weight polyvinyl alcohol possibly alone or in combination with a higher molecular weight polyvinyl alcohol. The molecular weight can be indicated by the viscosity of the polyvinyl alcohol polymer when contained in a 4% by weight aqueous solution at 20° C. In general, the viscosity of the 4% solution can be greater than about 4 cP, such as greater than about 10 cP, such as greater than about 15 cP, such as greater than about 20 cP, such as greater than about 25 cP, such as greater than about 30 cP. The viscosity is generally less than about 80 cP, such as less than about 60 cP, such as less than about 55 cP, such as less than about 50 cP, such as less than about 45 cP, such as less than about 40 cP, such as less than about 35 cP. The viscosity of the polyvinyl alcohol is the Brookfield viscosity of the polymer using spindle 31 @ 3 rpm.

The melting point of the polyvinyl alcohol polymer can generally be from about 120° C. to about 235° C. The melting point of the polymer, for instance, can be greater than about 125° C., such as greater than about 135° C., such as greater than about 145° C., and generally less than about 220° C., such as less than about 200° C., such as less than about 180° C., such as less than about 160° C.

The dried coating can generally contain one or more polyvinyl alcohol polymers in an amount greater than about 20% by weight and in an amount up to 100% by weight, including all increments of 1% by weight therebetween. For example, one or more polyvinyl alcohol polymers can be present in the dried coating in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight. One or more polyvinyl alcohol polymers can be present in the dried coating in an amount less than about 90% by weight, such as in an amount less than about 70% by weight, such as in an amount less than about 50% by weight, such as in an amount less than about 30% by weight.

One or more polyvinyl alcohols can be combined with various other additives and ingredients to form the coating. For example, one or more additives can be added to the coating in order to adjust the thermal lamination characteristics of the coating, in order to change other physical properties of the coating, in order to change the color of the coating, in order to improve the clarity of the coating, or the like.

In one embodiment, the coating contains a coating plasticizer. The coating plasticizer can be added to the coating in order to lower the overall melting temperature so that the coating will bond to other substrates at lower temperatures. The coating plasticizer, for instance, may comprise glycerol, ethylene glycol, diethylene glycol, triethylene glycol, polyethylene glycol, trimethylol propane, trimethylene glycol, tetramethylene glycol, butane diol, neopentyl glycol, or a fatty acid monoglyceride.

When present, one or more plasticizers can be contained in the dried coating in an amount greater than about 5% by weight, such as in an amount greater than about 8% by weight, such as in an amount greater than about 10% by weight, such as in an amount greater than about 15% by weight, such as in an amount greater than about 20% by weight, such as in an amount greater than about 25% by weight. One or more plasticizers can be present in the coating in an amount less than about 50% by weight, such as in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 18% by weight. One or more coating plasticizers can be added to the coating composition, for instance, in order for the coating to have a melting point of less than about 170° C., such as less than about 150° C., such as less than about 140° C., and generally greater than about 120° C.

In addition to one or more plasticizers and one or more polyvinyl alcohol polymers, the coating can also contain a binder. For example, the binder can comprise a starch. Starch can be present in the coating generally in an amount from about 3% by weight to about 53% by weight. For example, the coating can optionally contain starch in an amount greater than about 10% by weight, such as in an amount greater than about 20% by weight, and generally in an amount less than about 50% by weight, such as in an amount less than about 45% by weight, such as in an amount less than about 40% by weight.

In addition to the above ingredients, the coating of the present disclosure may also contain one or more fillers. Fillers may be added to the coating in order to affect the optical properties of the coating, prevent blocking prior to thermal lamination, or for various other reasons. Examples of fillers that may be added to the coating include clays, metal oxides, and the like. In one aspect, for instance, kaolin clay particles may be added to the coating. Filler particles can be present in the coating generally in an amount from about 0.1% by weight to about 30% by weight. For instance, one or more fillers can be incorporated into the coating such that the dried coating contains the fillers in an amount from about 1% by weight to about 25% by weight, such as from about 3% by weight to about 12% by weight.

Various other ingredients can be incorporated into the coating including an acid, a buffer agent, a defoamer, a colorant, or the like.

In order to form a coating composition in accordance with the present disclosure, the different components can be mixed and heated and applied to a film. In one aspect, a solvent may be added to the coating composition that is later evaporated during application to the film. Solvents that can be used include, for instance, toluene, an alcohol such as ethanol, acetone, or the like.

The coating composition can be applied to a film layer using any suitable technique. In one embodiment, for instance, the film layer is extrusion coated with the coating composition. For example, the coating composition can be applied to the film layer using knife coating, slot coating, or any other suitable technique. In addition, the coating composition can also be applied to a film layer through solvent or cast coating.

Optionally, a primer layer can be positioned between the film surface and the coating. The primer layer can have a thickness of less than about 5 microns, such as less than about 3 microns and generally greater than about 0.3 microns. The primer layer can comprise an acrylic polymer or polyurethane and can improve adhesion between the film surface and the coating. In one embodiment, the primer layer can be a single or multi-component, aqueous polymeric dispersion containing a polyethylene acrylic acid.

The film layer may comprise any suitable thermoplastic polymer sheet material useful for thermal lamination applications. The thermoplastic polymer film can be transparent or translucent. The film layer can possess surface characteristics and other physical properties such as flexibility, durability, hardness, scratch resistance, and the like. In one aspect, the film can be used for protecting a paper substrate, such as for protecting a printed surface to which the film layer may be laminated. Thermoplastic polymer film layers that may be coated with the coating composition include oriented polypropylene films, non-oriented polypropylene films, polyester films, polyamide films, polyvinyl chloride films, polycarbonate films, and the like.

In one aspect, however, the film layer can be made from a biodegradable material. For example, in an alternative embodiment, the film layer can be made from a cellulose-based material, such as regenerated cellulose or cellulose acetate, or can be made from a biodegradable polymer, such as a biodegradable polyester polymer. In still another embodiment, different biodegradable polymers can be combined together to form the film.

In one aspect, the film layer is made from a cellulose ester polymer, such as cellulose acetate. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses oftheMiscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof. Cellulose esters suitable for use in producing the composition of the present disclosure may, in some embodiments, have a molecular weight ranging from a lower limit of about 10,000, 15,000, 25,000, 50,000, or 85,000 to an upper limit of about 125,000, 100,000, or 85,000, and wherein the molecular weight may range from any lower limit to any upper limit and encompass any subset therebetween. In one embodiment, the number average molecular weight of the cellulose acetate may range from 40,000 amu to 100,000 amu, e.g., from 50,000 amu to 80,000 amu.

The cellulose acetate used in the composition may be cellulose diacetate or cellulose triacetate. In one embodiment, the cellulose acetate comprises primarily cellulose diacetate. In one embodiment, for instance, the cellulose acetate can have a degree of substitution of from about 2.3 to about 2.7, such as from about 2.4 to about 2.5. In one embodiment, the cellulose acetate can have a degree of substitution of about 2.45.

In some embodiments, the cellulose acetate in the composition comprises less than 1 wt. % cellulose triacetate, e.g., less than 0.5 wt. % or less than 0.1 wt. %. In some cases, the cellulose acetate in the composition consists essentially of cellulose diacetate.

In order to form a film, the cellulose acetate in powder or flake form is combined with a solvent and formed into a dope. The dope can then be used in a solvent casting process to form a film. Alternatively, the cellulose acetate can be formulated and injection molded into pellets that may be formed into a film.

When forming a cast film, as described above, the cellulose acetate can be in the form of flakes that are combined with a solvent. The flake form of cellulose acetate may have an average flake size from 5 μm to 10 mm, as determined by sieve analysis. The flake can have low moisture content, optionally comprising less than 6 wt. % water, e.g., less than 5 wt. % water or less than 2.5 wt. % water. In terms of ranges, the flake form may have from 0.01 to 6 wt. % water, e.g., from 0.1 to 2.5 wt. % water or from 0.5 to 2.45 wt. % water.

In forming the solvent cast film, the cellulose acetate may optionally be combined with a film plasticizer. The film plasticizer may vary widely. Suitable film plasticizers may, in some embodiments, include, but are not limited to, triacetin, trimethyl phosphate, triethyl phosphate, tributyl phosphate, triphenyl phosphate, tris(2-chloro-1-methylethyl) phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, propylene carbonate, C1-C20 diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof. In some embodiments, film plasticizers may be food-grade film plasticizers. Examples of food-grade film plasticizers may, in some embodiments, include, but are not limited to, triacetin, trimethyl citrate, triethyl citrate, tributyl citrate, eugenol, cinnamyl alcohol, methoxy hydroxy acetophenone (acetovanillone), vanillin, ethylvanillin, polyethylene glycols, and the like, and any combination thereof.

In one embodiment, the plasticizer is selected from the group consisting of 1,2,3-triacetoxypropane (triacetin), tributyl citrate, diethyl phthalate, triethyl citrate, triphenyl phosphate, tris(clorisopropyl)phosphate, dimethyl phthalate, bornan-2-one, PEG-DGE, PPG-DGE, tributyl phosphate, and combinations thereof. In one embodiment the plasticizer comprises a phthalate plasticizer, such as diethyl phthalate.

The film layer, in one embodiment, comprises from 60 wt. % to 95 wt. % cellulose acetate, e.g., from 65 wt. % to 90 wt. %, from 70 wt. % to 90 wt. %, or from 75 wt. % to 85 wt. %. In terms of lower limits, the composition may comprise at least 60 wt. % cellulose acetate, e.g., at least 65 wt. %, at least 70 wt. % or at least 75 wt. %. In terms of upper limits, the composition may comprise less than 95 wt. % cellulose acetate, e.g., less than 90 wt. % or less than 85 wt. %.

The film layer, in one embodiment, comprises from 5 wt. % to 40 wt. % plasticizer, e.g., from 5 wt. % to 35 wt. %, from 10 wt. % to 30 wt. %, or from 15 wt. % to 25 wt. %. In terms of lower limits, the composition may comprise at least 60 wt. % plasticizer, e.g., at least 5 wt. %, at least 10 wt. % or at least 15 wt. %. In terms of upper limits, the composition may comprise less than 95 wt. % plasticizer, e.g., less than 40 wt. %, less than 35 wt. %, less than 30 wt. %, or less than 25 wt. %.

As described above, alternatively, the film layer can be made from a regenerated cellulose, such as cellophane.

Alternatively, the film layer can be made from a biodegradable polyester alone or in combination with a cellulose acetate. For example, in one embodiment, the film layer can be made from polylactic acid.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

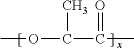

The polylactic acid typically has a number average molecular weight (“Mₑ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

The polylactic acid may also have an apparent viscosity of from about 50 to about 600 Pa·scal seconds (Pa·s), in some embodiments from about 100 to about 500 Pa·s, and in some embodiments, from about 200 to about 400 Pa·s, as determined at a temperature of 190° C. and a shear rate of 1000 sec⁻¹. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

The film layer can be made exclusively from polylactic acid or may be combined with other polymers and additives.

In another embodiment, the film layer can contain a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

The film layer made in accordance with the present disclosure may further comprise one or more additional additives, e.g., tackifiers, flame retardants, antioxidants, antibacterial agents, antifungal agents, colorants, pigments, dyes, UV-stabilizers, viscosity modifiers, processing additives, aromas, and the like, and any combination thereof. The amount of the additives may vary widely. Generally speaking the one or more additives may be present in an amount ranging from 0.01 to 10 wt. %, based on the total weight of the composition, e.g., from 0.03 to 2 wt. %, or from 0.1 to 1 wt. %.

Tackifiers may, in some embodiments, increase the adhesive properties of the composition described herein. Tackifiers suitable for use in conjunction with the composition described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, and the like, any derivative thereof, and any combination thereof. In some embodiments, tackifiers suitable for use in conjunction with the composition described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

Flame retardants suitable for use in conjunction with the composition described herein may, in some embodiments, include, but are not limited to, phosphates, catechol phosphates, resorcinol phosphates, aromatic polyhalides, and the like, and any combination thereof.

Antifungal agents suitable for use in conjunction with the composition described herein may, in some embodiments, include, but are not limited to, polyene antifungals, e.g., natamycin, rimocidin, filipin, nystatin, amphotericin B, candicin, and hamycin, imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, and any combination thereof.

Colorants, pigments, and dyes suitable for use in conjunction with the composition described herein may, in some embodiments, include, but are not limited to, plant dyes, vegetable dyes, titanium dioxide, silicon dioxide, tartrazine, El 02, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, nickel titanate, benzimidazolone orange gl, solvent orange 60, orange dyes, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL® dyes (an auxochrome, available from BASF) (e.g., Yellow 3GL, Fastusol C Blue 74L), and the like, any derivative thereof, and any combination thereof. In some embodiments, when the colorant is titanium dioxide is utilized as the colorant, the titanium dioxide may also function to increase the stiffness of the film. In one embodiment, solvent dyes may be employed.

In one embodiment, the composition used to form the film is free of any conventional anti-blocking agents, such as various particles including oxides, carbonates, talc, and the like.

In some embodiments, the composition further comprises a releasing agent, which allows the resulting film to release from various components during or after the production process, e.g., releasing from a casting band. In one embodiment, the composition comprises from 0.01 wt. % to 10 wt. % releasing agent, e.g., from 0.05 wt. % to 5 wt. %, from 0.05 wt. % to 1 wt. %, or from 0.05 wt. % to 0.5 wt. %. In one embodiment, the releasing agent comprises stearic acid or sorbitan monostearate. The releasing agent is preferably added to, e.g., mixed into, the dope. In such cases, the release agent preferably is dissolved into the dope. In one embodiment, the releasing agent is deposited or injected onto the casting band upon which the composition is cast. As the composition is released from the casting band, some of the releasing agent may remain with the composition and/or some of the release agent may remain with the casting band (based on the attraction of the release agent to the metal).

The film layer that receives the coating composition in accordance with the present disclosure can have many desired characteristics depending upon the final use of the film. In many applications, for instance, film layers can be selected that are transparent or translucent. For instance, when used as a protective layer in a thermal lamination process, using a transparent or translucent film provides protection to the underlying substrate while still making the underlying substrate viewable through the film. For example, using a transparent or translucent film may be desirable when the film is used to laminate paper substrates, particularly paper substrates that are printed with text and/or designs. The film can also have a matte finish in certain applications.

For many thermal lamination applications, the film layer is generally formed with a relatively low thickness. For instance, the film layer can have a thickness of less than about 50 microns, such as less than about 40 microns, such as less than about 30 microns, such as less than about 25 microns, such as less than about 20 microns. The film thickness is generally greater than about 8 microns, such as greater than about 10 microns, such as greater than about 14 microns. In other applications, however, thicker films may be desired. For example, in other applications, the film layer can have a thickness of from about 50 microns to about 200 microns.

The coating composition of the present disclosure can be applied to one or both surfaces of the film layer using various methods and techniques. In one embodiment, for instance, the coating composition can be applied to the film layer as the film layer is being formed. In this embodiment, the coating composition can be dried using the same heat that is used to form the film layer.

Alternatively, the film layer can be formed and then later coated with the coating composition. In this embodiment, for instance, the coating composition can be applied to the film layer and then the film layer can be heated, such as in an oven, in order to dry the coating composition and form a coating on the film.

The coating composition applied to the film can generally have a solids content of greater than about 25%, such as greater than about 35%, such as greater than about 45%, and generally less than about 70%, such as less than about 60%, such as less than about 55%. The coating composition can be formulated to have fluid-like properties that allow the composition to form a very thin coating on the film layer. The coating thickness prior to drying, for instance, can be less than about 30 microns, such as less than about 20 microns, such as less than about 15 microns, such as less than about 12 microns, and generally greater than about 5 microns. The coating composition can be applied to a surface of the film layer in an amount of greater than about 2 gsm, such as greater than about 4 gsm, such as greater than about 6 gsm, such as greater than about 8 gsm, and generally less than about 50 gsm, such as less than about 40 gsm, such as less than about 30 gsm, such as less than about 20 gsm, such as less than about 15 gsm, such as less than about 12 gsm.

Once dried, the coating formed on the film layer can have a thickness of less than about 30 microns, such as less than about 20 microns, such as less than about 15 microns, such as less than about 10 microns, such as less than about 8 microns, such as less than about 5 microns, and generally greater than about 0.1 micron, such as greater than about 0.5 microns.

The coated film of the present disclosure is well suited for many different types of applications. The coated film, for instance, can be used in almost any suitable thermal lamination process. The coated film, for instance, can be used to laminate the film to planar substrates or to three-dimensional substrates. For instance, the substrate can be made from a metal or from a polymer, such as polyester.

In one application, the coated film of the present disclosure can be used to thermally laminate a paper substrate. As used herein, a paper substrate refers to any substrate containing cellulosic fibers and can include a paper, a paperboard, cardboard, and the like. The paper substrate can include printed matter on a surface of the substrate. The coated film can be applied over the printed matter for protecting the paper substrate. For instance, the film can be scratch resistant, can be resistant to smudging, and can also provide some water resistance.

All different types of products can be made with the coated film of the present disclosure. For instance, the coated film of the present disclosure can be used to produce magazine pages, magazine covers, and all different types of packaging, such as various food boxes. Of particular advantage, once discarded, the laminated product can be biodegradable.

In order to laminate the coated film to a substrate, the film is first exposed to a temperature greater than the softening point of the coating. More particularly, the coating on the film is heated to a temperature sufficient to render the composition tacky so that the film will adhere to an adjacent surface. For instance, the film can be exposed to a temperature of greater than about 75° C., such as greater than about 80° C., such as greater than about 90° C., such as greater than about 100° C. The temperature is generally lower than the thermal degradation temperature of the film or the components that make up the coating. For instance, the temperature is generally less than about 180° C., such as less than about 140° C.

The film can be heated in any suitable manner. In one application, for instance, the coated film can be placed in contact with a heated drum. The uncoated side of the film can contact the drum. The drum can be at a temperature as described above.

Once heated, the coated film is then placed in contact with a substrate for laminating the film to the substrate. In one embodiment, for instance, the coated film can be heated using a drum and then fed into a nip where the coated film contacts an adjacent substrate for forming a laminated product. Once heated, the coated film need only contact the substrate for a short period of time for a sufficient and strong bond to form. For instance, the retention time within the nip can be less than 1 second, such as less than about 0.8 seconds, such as even less than about 0.5 seconds.

Once coated on a film, the coating of the present disclosure can have a semi-transparent or opaque appearance. Once heated and laminated to a substrate, however, the coating becomes transparent or translucent.

Alternatively, the coated film of the present disclosure can be used in a thermoforming process. During thermoforming, the coated film is heated, stretched, and then manipulated into a desired three-dimensional shape. The film can be formed over a convex or male mold or a concave or female mold. There are two main types of thermoforming typically referred to as vacuum forming or pressure forming. Both types of thermoforming use heat and pressure in order to form a film into its final shape. During vacuum forming, a plastic film is placed over a mold and vacuum is used to manipulate it into a three-dimensional article. During pressure forming, pressure optionally in combination with vacuum forces are used to mold the film into a shape.

The coated film of the present disclosure can be laminated to all different types of articles using thermoforming. For example, the coated film can be thermoformed to a tray made from cellulose fibers, such as a food tray. The thermoforming process can be used to produce automotive parts including door handles, cup holders, dashboards, and the like. In addition, consumer appliance components can also be formed through the process of the present disclosure, including handles and other parts. The process of the present disclosure can also be used to produce all different types of food and beverage containers.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A coated film comprising:
a film layer having a first surface and a second and opposite surface, the film layer comprising a biodegradable polymer; and
a coating applied to the first surface of the film layer, the coating comprising a partially hydrolyzed polyvinyl alcohol in an amount greater than about 15% by weight, the coating having a melting temperature of less than about 180° C.

2. A coated film as defined in claim 1, wherein the partially hydrolyzed polyvinyl alcohol is water soluble.

3. A coated film as defined in claim 1, wherein the coating further comprises a coating plasticizer.

4. A coated film as defined in claim 3, wherein the coating plasticizer comprises glycerol, ethylene glycol, diethylene glycol, triethylene glycol, polyethylene glycol, trimethylol propane, trimethylene glycol, tetramethylene glycol, butane diol, neopentyl glycol, or a fatty acid monoglyceride.

5. A coated film as defined in claim 3, wherein the partially hydrolyzed polyvinyl alcohol is contained in the coating in an amount greater than about 20% by weight, the partially hydrolyzed polyvinyl alcohol being present in the coating in an amount less than about 95% by weight, the coating plasticizer being present in the coating in an amount greater than about 5% by weight and in an amount less than about 30% by weight.

6. A coated film as defined in claim 1, wherein the coating is heat activatable for bonding to adjacent surfaces.

7. A coated film as defined in claim 1, wherein the coating has a melting point of from about 90° C. to about 150° C.

8. A coated film as defined in claim 1, wherein the coating is free of ethylene vinyl acetate.

9. A coated film as defined in claim 1, wherein the coating has a thickness of less than about 20 microns.

10. A coated film as defined in claim 1, wherein the coating comprises an extruded layer applied to the first surface of the film layer.

11. A coated film as defined in claim 1, wherein the film layer comprises cellulose acetate.

12. A coated film as defined in claim 1, wherein the film layer comprises regenerated cellulose.

13. A coated film as defined in claim 1, wherein the film layer comprises polylactic acid, a polyhydroxyalkanoate, or mixtures thereof.

14. A coated film as defined in claim 11, wherein the film layer further comprises a film plasticizer.

15. A coated film as defined in claim 1, wherein the polyvinyl alcohol is from about 74 mol % hydrolyzed to about 98 mol % hydrolyzed.

16. A coated film as defined in claim 1, wherein the partially hydrolyzed polyvinyl alcohol is not crosslinked.

17. A laminated product comprising:
a first layer having a first surface and a second surface, the first surface of the first layer being laminated to the coated film as defined in claim 1, the coating being positioned in between the first layer and the film layer.

18. A laminated product as defined in claim 17, wherein the first layer comprises a paper layer.

19. A laminated product as defined in claim 17, wherein the film layer is transparent or translucent.

20. A laminated product as defined in claim 18, wherein the first surface of the paper layer includes printed matter and wherein the printed matter is viewable through the coated film.
